(19) United States
(12) Patent Application Publication
(10) Pub. No.: US 2012/0001415 A1
(43) Pub. Date: Jan. 5, 2012

(54) QUICK COUPLING FOR FLUID PIPES

(75) Inventors: Andre HENSEL, Wachtersbach (DE); Patrick STÜBING, Wachtersbach (DE); Christian DESCH, Biebergemund (DE)

(73) Assignee: Veritas AG, Gelnhausen (DE)

(21) Appl. No.: 13/176,352

(22) Filed: Jul. 5, 2011

(30) Foreign Application Priority Data
Jul. 5, 2010 (DE) 102010026100.9

(51) Int. Cl. F16L 37/08; F16L 55/00

(52) U.S. Cl. 285/81

(57) ABSTRACT

The invention relates to a quick coupling for fluid pipes, comprising: a connector with a connecting piece and at least one connecting pipe transversely projecting from said connecting piece, the connecting piece being of the type that can be introduced into a receiving opening of a counterpart in a sealing manner and brought into latching engagement with said counterpart by means of a latching means; a securing means that can be converted from a locking position in which the latching engagement is secured against unlocking to an unlocking position in which the latching engagement can be disengaged; and a fastening means to which said securing means can be fixed in at least one position. To improve a quick coupling of the kind as mentioned above in such a manner that the securing means, after having inserted the connector into the receiving opening of the counterpart, can be mounted to the connector more easily, the fastening means is located, according to the invention, on a side of the connecting pipe facing away from the connecting piece.

The invention relates to a quick coupling for fluid pipes, comprising: a connector with a connecting piece and at least one connecting pipe transversely projecting from said connecting piece, the connecting piece being of the type that can be introduced into a receiving opening of a counterpart in a sealing manner and brought into latching engagement with said counterpart by means of a locking or latching means; a securing means that can be converted from a locking position in which the latching engagement is secured against unlocking to an unlocking position in which the latching engagement can be disengaged or released; and a fastening means to which said securing means can be fixed in at least one position.

Such a quick coupling is known from WO 2007/042344 A1. According to said quick coupling, the securing means can be fixed in different positions at the connector in a locking manner. The fastening means of the quick coupling is formed by locking grooves provided at the connecting piece which have to be applied thereto before the securing means is being assembled. After being inserted into the receiving opening of the counterpart, the connecting piece is no longer fully accessible so that the securing means should preferably be applied to the connecting piece before the connecting piece is inserted into the counterpart's receiving opening.

The invention is based on the object to improve a quick coupling of the kind mentioned above in such a manner that, after the connecting piece has been introduced into the counterpart's receiving opening, the securing means can be mounted to the connector more easily.

To solve the object basing the invention, a quick coupling for fluid pipes is provided, comprising: a connector with a connecting piece and at least one connecting pipe transversely projecting from said connecting piece, the connecting piece being of the type that can be introduced into a receiving opening of a counterpart in a sealing manner and brought into latching engagement with said counterpart by means of a latching means; a securing means that can be converted from a locking position in which the latching engagement is secured against unlocking to an unlocking position in which the latching engagement can be disengaged; and a fastening means to which said securing means can be fixed in at least one position, the fastening means being arranged on a side of the connecting pipe facing away from said connecting piece. The fastening means can be located directly on the connecting pipe or on another part of the connector that is above the connecting pipe or on the side of the connecting pipe facing away from the connecting piece. Accordingly, after the connecting piece has been introduced into the counterpart's receiving opening, the securing means can be mounted to the connector and actuated more easily, thereby facilitating mounting and handling of the quick coupling. Besides, checking the state of the securing means has become easier, as the part of the connector on the side of the connecting pipe facing away from the connecting piece can be viewed better and is more accessible than the part of the connector on the side of the connecting pipe facing the connecting piece.

Any advantageous developments of the invention are subject-matters of the sub-claims.

It may turn out to be advantageous to have the securing means fixed to the fastening means when being in its locking position and/or in its unlocking position preferably in non-positive and/or in positive, preferentially in locking manner. Thus, it is particularly easy for the user to find out via tactile feedback generated during the engagement or disengagement whether the securing means is in its securing and/or in its unlocking position. To this end, the securing means may comprise at least one, preferably flexible latching or locking section that can be locked in at least one locking position at the fastening means. Preferably, the latching section complies with at least one of the following requirements:
The latching section has its inner contour adapted to the outer contour of the connector and can be movably guided on the connector.
The latching section is formed resiliently.
The latching section is of an anchor structure.
The latching section includes at least one latching or snap-in protrusion and/or at least one snap-in reception which can be fixed in engaging manner to the securing means, the snap-in protrusion and/or the snap-in reception preferably being provided on a side of the latching section facing the fastening means.
The latching section comprises a preferably ribbed web extending from a base to a free end.
The latching section comprises at least one side arm branching off from the web substantially in the direction of the web base.
The latching section comprises a securing portion for locking the latching means in its locking position, said securing means preferably being arranged at the free end of the web.

The securing means may comprise multiple identical or different latching or locking sections. The securing means can be designed such that it overlaps the connector on the side of the connecting pipe facing away from the connecting piece. The latching sections may be provided on diametrically opposed sides of the connecting piece. Preferably, the latching section is arranged between two guide sections. The latching section and the guide sections preferably may substantially extend parallel to each other from the same base. The guide sections can be movably guided through the connector and/or the fastening means. The snap-in protrusion and/or the snap-in reception can be provided at the latching section and/or the guide section.

In an advantageous development of the invention, the securing means is guided between locking and unlocking position, at least section-wise, through the fastening means and/or through the connector, preferably through the connecting piece and/or through the connecting pipe. Connector and fastening means may form a guiding link having diverse guide sections used to support the securing means when converting between locking and unlocking position in torsion-proof, tilt-proof and/or sliding manner. Said guide sections preferably extend parallel to the direction into which the securing means is converted between locking and unlocking position, preferably parallel to the axis of the connecting piece. At least one guide section may be provided at an outer contour of the connecting piece, at the connecting pipe and/or at the fastening means. The guide section is preferably facing the connecting piece.

It may be proven beneficial to have the securing means converted between locking and unlocking position by being displaced or moved along the axis of the connecting piece. Thus, converting the securing means from the unlocking position to the locking position can be combined with an introducing movement of the connecting piece into the counterpart's receiving opening. However, it is also possible to combine converting the securing means from the locking position to the unlocking position with the retracting movement of the connecting piece from the counterpart's receiving opening, thus facilitating the handling of the quick coupling.

It may be advantageous to have the fastening means detachably connected to the connector, preferably to the connecting piece and/or to the connecting pipe. This allows to design the fastening means e.g. in the form of an add-on component and/or of an adapter so that one and the same securing means fits to different connectors.

It may be convenient to have the fastening means plugged onto the connector, preferably onto the connecting piece and/or the connecting pipe. Accordingly, the fastening means can be mounted onto or dismounted from the connector without any assistive and connecting equipment being required, thus further facilitating mounting or dismounting of the quick coupling.

It may be proven beneficial to have the fastening means connected to the connector, preferably to the connecting piece and/or the connecting pipe, in a permanent, captive and/or non-detachable manner. The fastening means may, at least section-wise, also be integrally formed with the connector, thereby reducing the danger of accidental disengagement of the fastening means from the connector and, thus, of any conceivable disengagement of the latching engagement between connector and counterpart.

It may be helpful to have the fastening means enclosing the connecting piece and/or the connecting pipe to its full extent. Preferably, the fastening means can be sealed around the connecting piece and/or the connecting pipe. To this end, parts of the fastening means that are complementary to one another can be connected around the connecting piece and/or the connecting pipe in either detachable or non-detachable manner. Preferentially, the fastening means encloses the connecting piece and/or two connecting pipes protruding from the connecting piece in various or diametrically opposed directions to its/their full extent. This allows the fastening means to be connected to the connector in non-detachable manner.

It may be useful to have the quick coupling comprise a locking mechanism for locking the securing means in at least one position, preferably in the locking position, with regard to the fastening means. Thus, a third securing can be obtained so that the danger of unintentional solving of the latching engagement between latching means and counterpart can be reduced even more.

It may be convenient to have the securing means and the fastening means comprise surfaces that are lying flush against each other in one position, preferably in the locking position of the securing means. This enables the user to easily recognize whether or not the securing means is in the desired position. Preferably, said surfaces project away from the connecting piece in counter-insertion direction.

It may be proven advantageous to have the connecting pipe comprise at least one guide surface for movably guiding the securing means during the conversion between locking and unlocking position and/or to position the fastening means with regard to the connector in a torsion-proof and/or slide-proof manner. The guide surface may substantially be directed parallel to the axis of the connecting piece and/or orthogonal to the axis of the connecting pipe. As said guide surface is preferably spaced apart from the connecting piece, the securing means can be supported in a particularly torsion- and tilt-proof manner.

It may be proven favorable to have the connecting pipe comprise two guide surfaces being spaced apart along the axis of said connecting pipe. Said guide surfaces can be directed substantially parallel to the axis of the connecting piece and/or orthogonal to the axis of the connecting pipe. Said guide surfaces may also form a seat for a connecting section of the fastening means. Preferably, two connecting sections of the fastening means are positioned on two connecting pipes projecting from the connecting piece into various or diametrically opposed directions, between two guide surfaces, respectively, in torsion-proof and slide-proof manner. Thus, the fastening means can be fixed in a definite position to the connector.

It may be proven advantageous to have the latching means comprise two resilient latch arms protruding from the connecting piece in circumferential direction of the connecting piece and displaced to the connecting pipe. Preferably, the latch arms protrude in counter-insertion direction of the connecting piece and are resiliently designed in radial direction. The latch arms are preferably arranged in the circumferential direction of the connecting piece, preferably centrally between two connecting pipes. As a result, the connector can be kept in the middle of the counterpart's receiving opening. Furthermore, in this central position between two connecting pipes, the latch arms are easier accessible for the securing means.

It may be convenient to have the connector substantially designed in either X-, T-, Y- or L-shape, the connector preferably including two connecting pipes, the axes thereof being in one plane with the axis of the connecting piece, or the axes thereof being in two planes cutting in the region of the axis of the connecting piece. Thus, various connector configurations can be achieved.

An independent issue of the present invention relates to a construction kit for a quick coupling for fluid pipes, comprising: a connector with a connecting piece and at least one connecting pipe transversely projecting from said connecting piece, the connecting piece being of the type that can be introduced into a receiving opening of a counterpart in a sealing manner and brought into latching engagement with said counterpart by means of a latching means; a securing means for securing the latching engagement against unlocking; and a fastening means for fixing the securing means in at least one position, the connector, the securing means and the fastening means being connectable to each other such that the securing means is convertible between a locking position in which the latching engagement is secured against unlocking and an unlocking position in which the latching engagement can be released and that the securing means can be fixed to the fastening means in at least one position. Preferably, the fastening means can be arranged on a side of the connecting pipe facing away from the connecting piece. The above-mentioned advantages can, thus, be achieved. The quick coupling and the components thereof may comprise all of the above-mentioned features.

Preferred developments can be derived by combining the features according to the sub-claims with features according to the description.

### BRIEF DESCRIPTION OF THE FIGURES

FIG. 1a is a perspective view of the quick coupling according to a first embodiment of the invention having a compatible counterpart, with the securing means being in the unlocking position.

FIG. 1b is a simplified sectional view of the quick coupling of FIG. 1a.

FIG. 2a is a perspective view of the quick coupling of FIG. 1a, with the securing means being in the locking position.

FIG. 2b is a simplified sectional view of the quick coupling of FIG. 2a.

FIG. 3 is an enlarged detail of the securing means of the quick coupling according to FIGS. 1a and 1b.

FIG. 4 is a perspective view of a quick coupling according to another embodiment of the invention, with the connector having two connecting pipes the axes of which lying in different planes cutting in the region of the axis of the connecting piece.

FIG. 5 shows a quick coupling according to a third embodiment of the invention having a connector according to FIG. 4, with the fastening means being mounted onto the connector in non-detachable manner.

FIG. 6 shows a detail of a fastening means according to the third embodiment of the invention.

FIG. 7 shows a quick coupling according to a fourth embodiment of the invention, with the securing means being in the unlocking position and a latching means being in the unlatching position.

FIG. 8 shows the quick coupling of FIG. 7, with the securing means being in the locking position and the latching means being in the latching position.

FIG. 9 shows a quick coupling according to a fifth embodiment of the invention, with the fastening means being mounted onto the connector in non-detachable manner and comprising welded components.

FIG. 10 shows a quick coupling according to a sixth embodiment of the invention, with the securing means being in the unlocking position.

FIG. 11 is a perspective view of the fastening means of the quick coupling according to FIG. 10.

FIG. 12 is a perspective view of the securing means of the quick coupling according to FIG. 10.

FIG. 13 shows the quick coupling according to FIG. 10 being inserted into the receiving opening of a counterpart, with the securing means being in the locking position.

FIG. 14a shows a quick coupling according to a seventh embodiment of the invention, with the securing means being in the unlocking position.

FIG. 14b is a schematic sectional view of the quick coupling according to FIG. 14a.

FIG. 15a shows the quick coupling according to FIG. 14a, with the securing means being in the locking position.

FIG. 15b is a schematic sectional view of the quick coupling according to FIG. 15a.

FIG. 16 is a perspective view of a quick coupling according to an eighth embodiment of the invention.

FIG. 17 is another perspective view of the quick coupling according to FIG. 16.

FIG. 18 is a perspective view of a quick coupling according to a ninth embodiment of the invention, with the securing means being in the unlocking position.

FIG. 19 shows the quick coupling according to FIG. 18, with the securing means being in the locking position.

### DETAILED DESCRIPTION OF THE PREFERRED EMBODIMENTS

### Embodiment 1

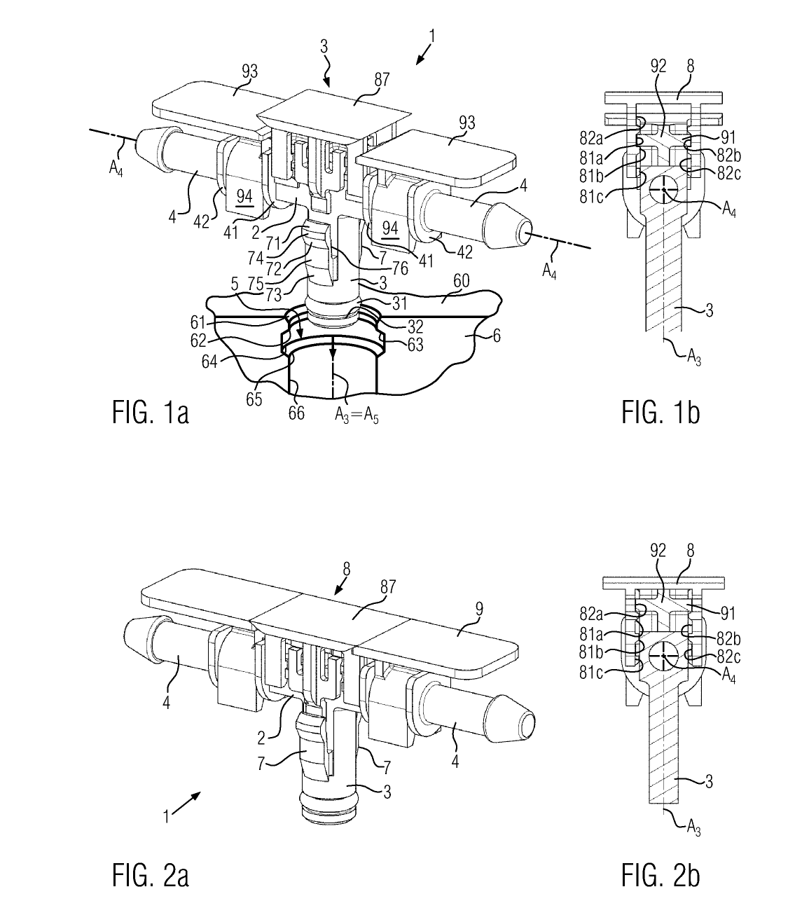

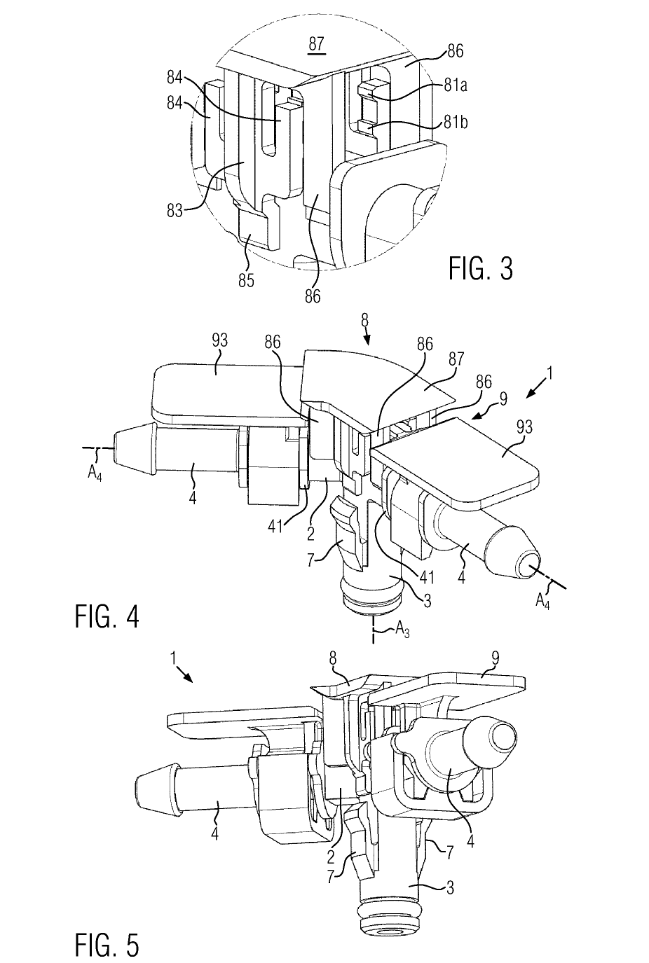

The first embodiment of the invention described in the following with regard to FIGS. 1 to 3 relates to a quick coupling 1 for fluid pipes in the form of a leak-oil connector. FIG. 1a is a perspective view of the inventive quick coupling 1 as well as of a counterpart 6 with a suitable receiving opening 5, with the securing means 8 being in the unlocking position.

The inventive quick coupling 1 comprises an integrally formed, substantially T-shaped connector 2 of a glass-fiber reinforced plastic (e.g. PA66+6 GF30 or Polyamide 66+6 with a 30% glass-fiber portion) including a connecting piece 3 and two connecting pipes 4 transversely protruding from said connecting piece 3.

Connecting piece 3 is introducible into receiving opening 5 of counterpart 6 in a sealing manner. In the direction of introduction of quick coupling 1, indicated by an arrow, a sealing ring 31 is held in a circumferential groove 32 at the end of connecting piece 3.

Any leak-oil pipes to be connected can be attached to the cone-shape end pieces of connecting pipes 4. Axes A4 of connecting pipes 4 and axis A3 of connecting piece 3 are lying in one and the same plane. To this end, axes A4 of connecting pipes 4 each form an angle of 90° with axis A3 of connecting piece 3. Axis A3 of connecting piece 3 coincides, when being in the inserted condition, with axis A5 of receiving opening 5 as intended.

Receiving opening 5 defined in counterpart 6 comprises, starting from a surface 60 of counterpart 6, a chamfer 61 in the entrance region, a snap-in protrusion 62, a cone-shape widening 63, an undercut 64, a cone-shape tapering 65 and a holding area 66.

Two identically formed resilient latching or latch arms 7 protrude on diametrically opposed sides of the axis of connecting piece 3 from connecting piece 3 in counter-insertion direction and can be brought into latching engagement with counterpart 6. Each of said latch arms 7 comprises a wedge face 71 substantially being formed at the free end of latch arm 7 adjacent to the largest radius of latch arm 7 and protruding away from the direction of insertion of connecting piece 3. Wedge face 71 has an angle of about 45° to axis A3 of connecting piece 3. Further, each latch arm 7 is provided at the outside with two wedge faces 72, 73 protruding away from connecting piece 3 in the direction of insertion, with wedge face 72 being formed adjacent to the greatest radius of latch arm 7 and wedge face 73 being formed directly adjacent to the cylindrical part of connecting piece 3. Wedge faces 72, 73 each comprise an angle of about 20° with regard to axis A3 of connecting piece 3. Due to the different angles of inclination of wedge faces 72, 73 with regard to axis A3 of connecting piece 3, an inserting force of connecting piece 3 is smaller than a retracting force of connecting piece 3. Glide surfaces 74 and 75 are provided between wedge faces 71, 72 and 73 and extend substantially parallel to axis A3 of connecting piece 3, glide surface 74 defining the largest radius of latch arm 7. The outer contour of latch arm 7 has been adapted to the inner contour of receiving opening 5. In inner side 76 of latch arm 7 facing towards connecting piece 3 is in the form of a wedge face and is continuously inclined from its low end up to the end of latch arm 7 with regard to the axis of connecting piece 3, preferably at an angle of about 10°.

Securing means 8 is integrally formed of plastic or metal and overlaps connector 2 on a side of connecting pipe 4 facing away from connecting piece 3. To this end, securing means 8 comprises multiple snap-in protrusions 81a, 81b, 81c restricting or defining a variety of snap-in receptions 82a, 82b, 82c. Snap-in protrusions 81a, 81b, 81c and snap-in receptions 82a, 82b, 82c are provided at the inner sides facing each other of two resilient, substantially anchor-shaped latching sections. Said latching sections each comprise a ribbed web 83 at the end of which a securing portion 85 is provided, as well as two side arms 84. Side arms 84 are each fastened substantially in a center region of web 83 and extend opposite to the direction of extension of web 83 so as to form the anchor-shaped structure. Both, web 83 and side arms 84 have resilient properties. Two guide sections 86 respectively protrude from a substantially flat actuating section 87 in parallel, in the same direction and in the same plane alongside of each latching section so that two guide sections 86 laterally flank each of said latching sections. Actuating section 87 constitutes the common basis of all latching sections and guide sections 86. Securing means 8 is located on fastening means 9 in torsion-proof, movable and captive manner and can be converted either by displacement or movement in the or opposite to the direction of insertion between the unlocking position in which the latching engagement of quick coupling 1 can be unlocked and the locking position in which such latching engagement is secured. Snap-in protrusions 81a, 81b, 81c and snap-in receptions 82a, 82b, 82c provided at the inner sides of the latching sections facing each other serve to fix and catch securing means 8 in the unlocking and in the locking position at fastening means 9.

Fastening means 9 integrally formed of plastic or metal comprises a substantially flat fastening section 91 to which securing means 8 can be fixed in a locked manner. Fastening section 91 substantially extends in a plane orthogonally arranged to axis A3 of connecting piece 3. Stiffening longitudinally and transversely running ribs 92 preferably extend perpendicularly to fastening section 91. Each of said two ends of fastening section 91 is provided with an actuating section 93 having a surface lying, when in locking position, flush against a surface of securing means 8, and having a connecting section 94 that can be fixed on one of said connecting pipes 4 in a locking manner. Each of said connecting sections 94 exactly fits between two guide surfaces 41, 41 integrally formed with connecting pipes 4 and extending perpendicularly to axes A4 of connecting pipes 4. Contours and dimensions of connector 2, fastening means 9 and securing means 8 match to each other such that connector 2 and fastening means 9 constitute a guiding link for securing means 8 so that securing means 8 can be converted between unlocking and locking position in torsion-proof, tilt-proof and sliding manner. To this end, guide sections 86 of securing means 8 are received in sliding manner between actuating sections 93 and fastening means 9 and between inner guide surfaces 41. The latching sections have an inner contour matching to the outer contour of connecting piece 3 and slide or glide on the diametrically opposing outer sides of connecting piece 3.

The preferred application of the invention will be described in the following in detail with regard to the drawings.

The quick coupling 1 is inserted in the direction of insertion into receiving opening 5 of counterpart 6, while securing means 8 is preferably caught in the unlocking position at fastening means 9. During the insertion, connecting piece 3 is first centered in receiving opening 5 by means of wedge faces 72, 73 facing away from connecting piece 3. Wedge faces 72 facing away from connecting piece 3 in the direction of insertion lie flat against snap-in protrusion 62 without any force being applied in the direction of insertion (insertion force). Applying an insertion force causes interaction of latch arms 7 with snap-in protrusion 62 via wedge engagements so that latch arms 7 are radially displaced towards the inside, in order to slide with glide surface 75 over snap-in protrusion 62. Owing to the resilient properties of latch arms 7, same return to a position projecting away from connecting piece 3 so that latch arms 7 find their way into undercut 64 behind snap-in protrusion 62 where they are caught or locked in place. Wedge faces 71 facing away from connecting piece 3 in counter-insertion direction get into engagement with snap-in protrusion 62 and widening 63, with latch arms 7 being entirely accommodated in receiving opening 5 and not projecting from receiving opening 5 over surface 60 of counterpart 6. Thus, quick coupling 1 is in latching engagement with counterpart 6. According to the unlocking position, schematically shown in FIG. 1a, fastening section 91 is positioned in the second snap-in reception 82b. Securing means 8 is not in latching engagement with latch arms 7 so that latch arms 7 can be radially urged towards the inside.

Securing means 8 is now converted by means of displacement or movement with regard to fastening means 9 in the direction of insertion from the unlocking to the locking position. When converting the securing means 8 from the unlocking to the locking position, securing sections 85 interact with latch arms 7 such that latch arms 7 cannot be displaced or urged towards the inside in radial direction when they are in the locking position. Moreover, latch arms 7 are spread-off or opened and urged deeper into receiving opening 5 by means of a wedge engagement with snap-in protrusion 62. Thus, a secondary securing can be realized. In the locking position, fastening section 91 is positioned in the first snap-in reception 82a so that securing means 8 is fixed or caught to fastening means 9. In the locking position, the surface of actuating section 87 of securing means 8 facing away from connecting piece 3 extends flush against the surfaces of actuating sections 93 of fastening means 9 facing away from connecting piece 3.

Securing means 8 may again be converted from the locking position to the unlocking position by movement in counter-insertion direction of securing means 8. In the unlocking position, securing means 8 is not in engagement with latch arms 7 so that latch arms 7 can be radially urged towards the inside. Applying a force in counter-insertion direction (pull-out force) causes that quick coupling 1 can be pulled out of reception opening 5. In the unlocking position, securing means 8 is again fixed or caught to fastening means 9, with fastening section 91 being located in the second snap-in reception 82b. Accordingly, securing means 8 can, thus, be converted from the unlocking position to the locking position in a reversible manner.

The subsequently following embodiments are substantially based on the first embodiment. Features serving for the same function were given the same reference numbers as in case of the first embodiment. From now on, only essential differences with regard to the first embodiment will be explained in more detail and, where possible, it is refrained from giving repetitions of the preceding description.

### Embodiment 2

The second embodiment of the invention will be described in the following with regard to FIG. 4. The statements refer to a condition in which securing means 8 is fixed to fastening means 9 which is mounted to connector 2. Deviating from the first embodiment, axes A4 of connecting pipes 4 extend in a plane perpendicular to axis A3 of connecting piece 3 or in various planes cutting in axis A3 of connecting piece 3. To compensate the different angles of axes A4 of connecting pipes 4, fastening section 91 of fastening means 9 is bent according to the course of axes A4. Moreover, at the side of a connecting pipe 4, guide sections 86 of securing means 8 are aligned substantially parallel to the plane spanned by axis A4 of the appertaining connecting pipe 4 and axis A3 of connecting piece 3. The latching sections also extend parallel to said plane. Further, at the side of the other connecting pipe 4, guide sections 86 are aligned substantially parallel to the plane spanned by axis A4 of the other connecting pipe 4 and axis A3 of connecting piece 3. As in the first embodiment, contours and dimensions of connector 2, fastening means 9 and securing means 8 match each other such that connector 2 and fastening means 9 form a guiding link for securing means 8 by which securing means 8 can be converted between unlocking and locking position in a torsion-proof, tilt-proof and sliding manner.

### Embodiment 3

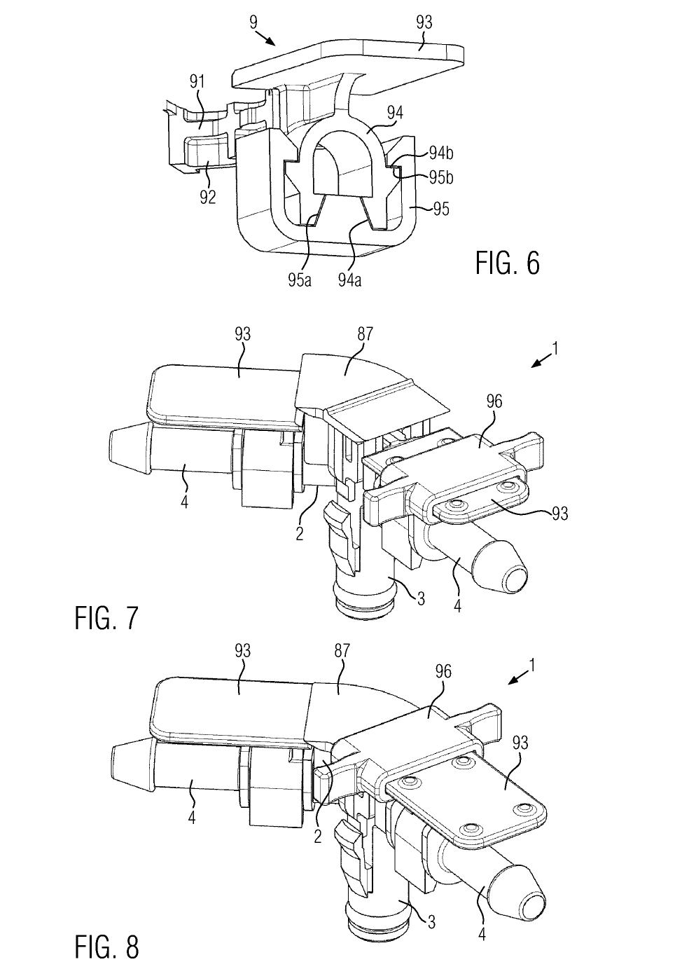

The third embodiment of the invention that is based on the second embodiment according to FIG. 4 will be described in the following with regard to FIGS. 5 and 6. Deviating from the second embodiment, fastening means 9 is mounted to connecting pipes 4 in an unsolvable manner. To this end, connecting section 94 of each fastening means 9 is caught in a positive-locking manner with a substantially W-shaped yoke 95 and closed around the circumference of the appertaining connecting pipe 4. As shown in FIG. 6, yoke 95 closes a receiving opening of connecting section 94 into which connecting pipe 4 has been received, a wedge-shaped protrusion 95a of yoke 95 being in a wedge engagement with two wedge faces 94a facing away from the reception at the ends of the legs of connecting section 94. Snap-in protrusions 95b provided at the inner sides of the free ends of yoke 95 are caught by snap-in protrusions 94b provided at the outer sides of the legs of connecting section 94. When yoke 95 snaps onto connecting section 94, snap-in protrusions 94b, 95b interact via wedge faces such that yoke 95 is easier to be locked to than to be unlocked from connecting section 94.

### Embodiment 4

The fourth embodiment of the invention that is also based on the second embodiment according to FIG. 4 will be explained in the following with regard to FIGS. 7 and 8. In addition to the second embodiment, fastening means 9 comprises a latching means 97 that can be converted between an unlatched state (FIG. 7), in which securing means 8 can be converted between the locking and the unlocking position, and a latched state (FIG. 8) in which securing means 8 is latched in the locking or latching state. In the locking position of securing means 8, the surfaces of actuating sections 87, 93 of securing means 8 and of fastening means 9 facing away from connecting piece 3 extend flush against each other. In this state, latching means 97 movably guided on an actuating section 93 of fastening means 9 can be moved over actuating section 87 of securing means 8 such that the movement of securing means 8 with regard to fastening means 9 is either locked, blocked and/or caught. Accordingly, securing means 8 cannot be converted from the locking position into the unlocking position. Thus, a tertiary securing has been realized.

### Embodiment 5

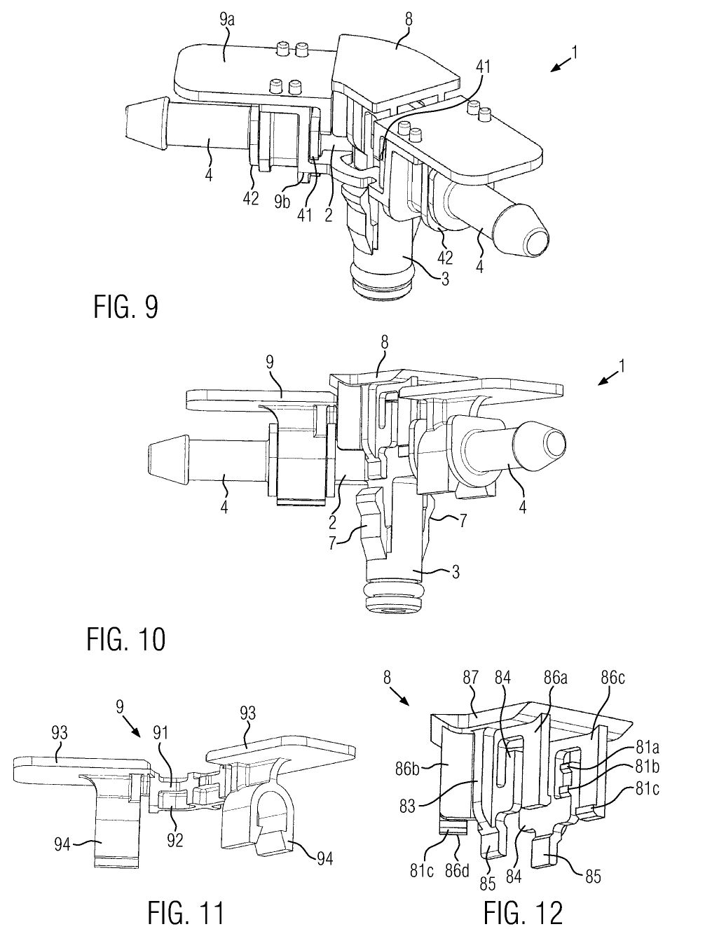

The fifth embodiment of the invention that is also based on the second embodiment according to FIG. 4 will be explained in the following with regard to FIG. 9. Deviating from the second embodiment, fastening means 9 comprises two complementary components 9a, 9b that can be arranged around connecting pipes 4 from different sides and welded to each other so as to connect fastening means 9 with connector 3 in a non-detachable manner. For mounting the components that can be welded, weld projections or cams of one component 9b are inserted through complementary weld projection openings of the other component 9a and then welded to each other so as to combine the two components in a positive locking and firmly joint manner. As to this, the lower component 9b comprises an opening through which connector 2 and securing sections 85 of securing means 8 are extending. In the condition as shown, fastening means 9 is closed around the entire circumference of connecting piece 3 and around the two connecting pipes 4. Components 9a, 9b can be fixed via inner and outer guide faces 41, 42 in exactly one position to connector 2 in a slide-proof and torsion-proof manner. Contours and dimensions of connector 2, fastening means 9 and securing means 8 match to each other such that connector 2 and fastening means 9 form a guiding link for securing means 8 by which securing means 8 can be converted between the unlocking and the locking position in torsion-proof, tilt-proof and sliding manner.

### Embodiment 6

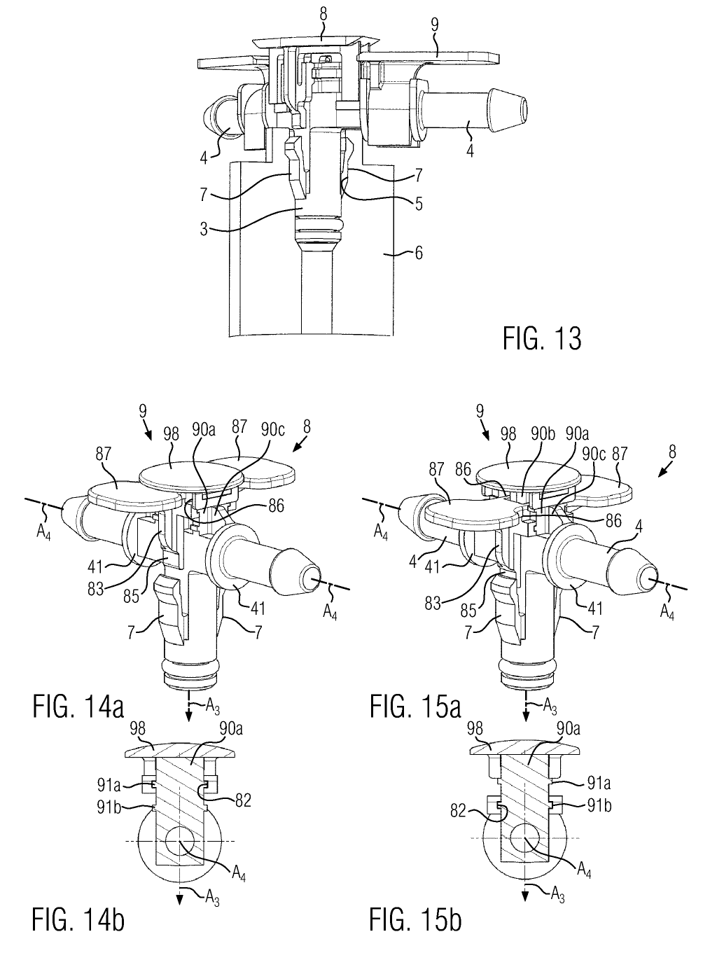

The sixth embodiment of the invention that is also based on the second embodiment according to FIG. 4 will be explained in the following with regard to FIGS. 10 to 13. FIG. 10 shows quick coupling 1 in the unlocking position of securing means 8. FIG. 11 is a perspective view of fastening means 9. FIG. 12 is a perspective view of securing means 8. Deviating from the second embodiment, securing means 8 comprises different latching sections and guide sections 86a, 86b, 86c, 86d arranged on different sides of connector 2 and fastening means 9. The latching section on the inner side of the curve of connector 2 (i.e. the side of the smaller angular distance of axes A4 of connecting pipes 4) comprises a ribbed web 83 with a securing portion 85 at its end and a side arm 84. Side arm 84 is provided between web 83 and first guide section 86a. Together with web 83 and arm 84, first guide section 86a forms a structure of about G-shaped form, the slot-shaped opening thereof extending in a direction facing away from actuating section 87. Second guide section 86b is connected to web 83 over its entire length and extends in another plane than first guide section 86a. The latching section on the outer side of the curve of connector 2 (i.e. the side of the larger angular distance of axes A4 of connecting pipes 4) is, as in case of the first embodiment, of anchor-shaped form. Third guide section 86c extends parallel to first guide section 86a and forms, together with web 83 and arm 84, a structure of about G-shaped form, the slot-shaped opening thereof extending in a direction facing away from actuating section 87. Fourth guide section 86d is provided, spaced apart from the latching section, on the outer side of the curve and extends parallel to second guide section 86b. Snap-in protrusions 81a, 81b, 81c are located at the opposing inner sides of latching sections and/or guide sections 86a, 86b, 86c, 86d. FIG. 13 shows quick coupling 1 when mounted into receiving opening 5 of counterpart 6, with securing means 8 being in the locking position.

### Embodiment 7

The seventh embodiment of the invention that is substantially based on the first embodiment according to FIGS. 1 to 3 will be described in the following with regard to FIGS. 14 and 15. Deviating from the first embodiment, connector 2 is of a substantially cross-shaped structure, with fastening means 9 being partially molded on a side of connecting pipes 4 facing away from connecting piece 3. Connector 2 is substantially of an X-shaped form. FIG. 14a is a perspective view of quick coupling 1, with securing means 8 being in the unlocking position. FIG. 14b is a schematic sectional view of quick coupling 1 of FIG. 14a. FIG. 15a is a perspective view of quick coupling 1, with securing means 8 being in the locking position. FIG. 15b is a schematic sectional view of quick coupling 1 of FIG. 15a.

Deviating from the first embodiment, securing means 8 comprises two latching sections each having a ribbed web 83 and a securing portion 85 at the end thereof, web 83 extending, as intended, parallel to axis A3 of connecting piece 3 and being of an inner contour adapted to the outer contour of connector 2 in order to be able to slide onto the outer side of connector 2. At the upper end of each of said webs 83 there is provided an actuating section 87. The two actuating sections 87 are connected to each other via two parallel guide sections 86.

Each of said inner sides of the latching sections facing each other is provided with a snap-in reception 82. When in the unlocking or the locking position, snap-in receptions 82 can be brought into latching engagement with latching sections 91, 91b of fastening means 9.

Fastening means 9 comprises three walls 90a, 90b formed together with latching sections 91a, 91b projecting from connecting pipes 4 parallel to each other and spaced apart from each other perpendicularly to the axes A4 of connecting pipes 4 on the side of connector 2 facing away from connector 2. Outer walls 90a are integrally connected via ribs 90c to the circular-shaped and disk-shaped guide surfaces 41 of connecting pipes 4. Each of said ribs 90c substantially extends in the plane spanned by axis A3 of connecting piece 3 and axes A4 of connecting pipes 4. Latching sections 91a, 91b protrude substantially perpendicularly to said plane from both sides of walls 90a, 90b. Two gap-shaped receptions are provided between outer walls 90a and center wall 90b for guiding guide sections 86 of securing means 8 in a sliding manner during the conversion between unlocking and locking position.

For mounting quick coupling 1, guide sections 86 of securing means 8 are inserted into the gap-shaped receptions between walls 90a, 90b. Subsequently, a substantially plate-shaped lid 98 is snapped onto the outer walls 90a of fastening means 9 so as to close the gap-shaped reception between walls 90a, 90b. Thus, securing means 8 is connected to fastening means 9 in non-releasable manner.

FIG. 14b is a schematic sectional view of the quick coupling according to FIG. 14a when in unlocking position. The section extends through one of the two walls 90a. As can be seen, when in the unlocking position, securing means 8 is in latching engagement with fastening means 9. To this end, snap-in receptions 82 are snapped onto latching sections 91a. Securing means 8 is in abutment with lid 98 serving as stopper. Moving securing means 8 towards the direction of insertion (arrow) can cause securing means 8 to be converted from the unlocking to the locking position.

FIG. 15b is a schematic sectional view of the quick coupling according to FIG. 15a when in the unlocking position. Again, the section extends through one of the two walls 90a. As can be seen, when in the locking position, securing means 8 is in latching engagement with fastening means 9. To this end, snap-in receptions 82 are snapped onto latching sections 91a. In this position, guide sections 86 are located at the bottoms of the gap-shaped receptions between walls 90a, 90b. Moving securing means 8 against the direction of in insertion (arrow) can cause securing means 8 to be converted from the locking position to the unlocking position again.

### Embodiment 8

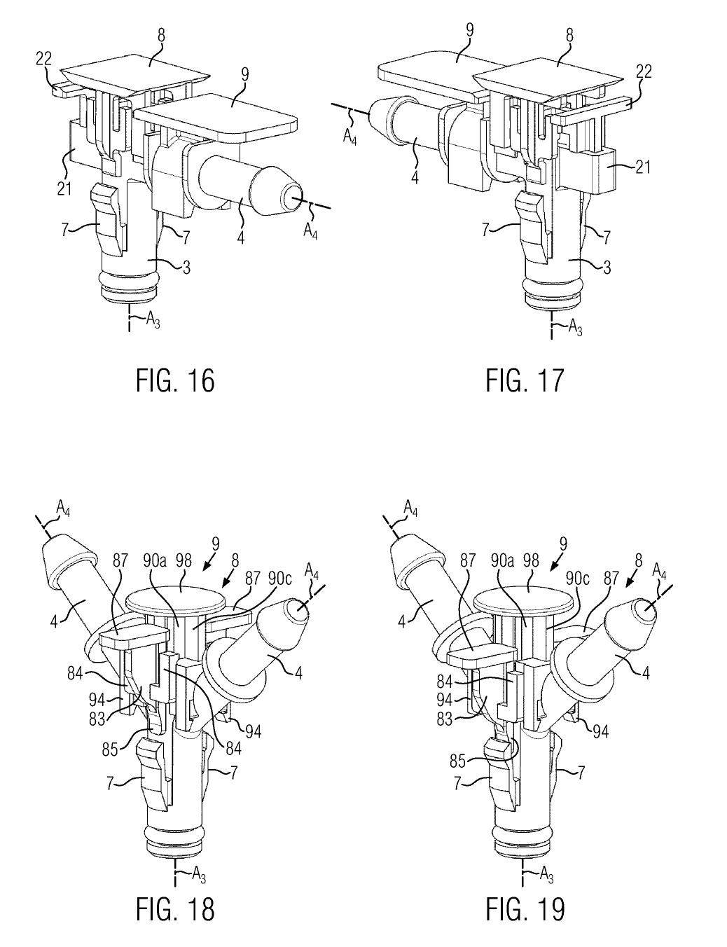

The eighth embodiment of the invention that is substantially based on the first embodiment according to FIGS. 1 to 3 will be described in the following with regard to FIGS. 16 and 17. FIGS. 16 and 17 are perspective views of quick coupling 1 seen from different sides.

Deviating from the first embodiment, quick coupling 1 comprises just one connecting pipe 4, axis A4 of which substantially being arranged orthogonally to axis A3 of connecting piece 3. On the diametrically opposing side of the first connecting pipe 4, a lug 21 with a T-shaped projection 22 is provided to which fastening means 9 can be fixed at one side thereof. When in the locking position, securing means 8 is in abutment with T-shaped projection 22, with a surface of securing means 8 facing away from connector 2 in a counter-insertion direction lining up precisely with a surface of fastening means 9 facing away from connector 2 in a counter-insertion direction. Connector 2 is substantially of an L-shaped form.

### Embodiment 9

The ninth embodiment of the invention that is substantially based on the seventh embodiment according to FIGS. 14 and 15 will be described in the following with regard to FIGS. 18 and 19. FIGS. 18 and 19 are perspective views of quick coupling 1 seen from different sides.

Deviating from the seventh embodiment, axes A4 of connecting pipes 4 extend at an angle of about 135°, respectively, to axis A3 of connecting piece 3, axes A4 of connecting pipes 4 and axis A3 of connecting piece 3, however, being in one plane. Connector 2 is substantially of a Y-shaped form.

As in the first embodiment, securing means 8 comprises two latching sections, each having a ribbed web 83 at the end of which a securing portion 85 is provided, and to side arms 84, web 83 extending, as intended, in the direction of insertion parallel to axis A3 of connecting piece 3 and each of said latching sections having an inner contour adapted to the outer contour of connector 2 so as to be able to slide on the outer side of connector 2. At the upper end of each of said webs 83 an actuating section 87 is provided, the two actuating sections 87 being connected to each other via a guide section. Each of said inner sides of said latching sections facing each other is provided with snap-in protrusions and snap-in receptions (not shown) that can be brought into latching engagement with latching sections of fastening means 9 when in the unlocking or the locking position.

Fastening means 9 comprises two walls 90a provided with latching sections projecting from connecting pipes 4 parallel to each other and spaced apart from each other perpendicularly to the plane spanned by axis A3 of connecting piece 3 and axes A4 of connecting pipes 4 on the side of connector 2 facing away from connecting piece 3. A gap-shaped reception is provided between walls 90a for movably guiding the guide section of securing means 8 when being converted between the unlocking and the locking position. Walls 90a are integrally connected via ribs 90c to connecting sections 94 that can be snapped onto connecting pipes 4. Each of said ribs 90c substantially extends in the plane spanned by axis A3 of connecting piece 3 and axes A4 of connecting pipes 4.

For mounting quick coupling 1, the guide section of securing means 8 is inserted into the gap-shaped reception between walls 90a. Subsequently, a substantially plate-shaped lid 98 is snapped onto outer walls 90a and ribs 90c of fastening means 9 so as to close the gap-shaped reception between walls 90a. Thus, securing means 8 is connected to fastening means 9 in non-releasable manner.

When being in the unlocking position according to FIG. 18, securing means 8 is in latching engagement with fastening means 9. To this end, securing means 8 is in abutment with lid 98 serving as a stopper. Moving securing means 8 in the direction of insertion (arrow) causes securing means 8 to be converted from the unlocking to the locking position.

When being in the locking position according to FIG. 19, securing means 8 is also in latching engagement with fastening means 9. In this position, the guide section is located at the bottom of the gap-shaped reception between walls 90a. Moving securing means 8 in counter-insertion direction (arrow) causes securing means 8 to be converted from the locking position to the unlocking position again.

1. A quick-release-coupling for fluid pipes, comprising:
a connector with a connecting piece and at least one connecting pipe transversely projecting from said connecting piece, the connecting piece being of a type that can be introduced into a receiving opening of a counterpart in a sealing manner and brought into latching engagement with said counterpart by a latching means;
a securing means having a locking position in which the latching engagement is secured against unlocking and an unlocking position in which the latching engagement is disengaged; and
a fastening means to which said securing means will be fixed in at least one position, wherein the fastening means is arranged on a side of the connecting pipe facing away from the connecting piece.

2. The quick coupling according to claim 1, wherein the securing means will be fixed to the fastening means when being in its locking position and/or in its unlocking position.

3. The quick coupling according to claim 1, wherein the securing means is guided between the locking and the unlocking position, at least section-wise, through the fastening means and/or through the connector.

4. The quick coupling according to claim 1, wherein the securing means is converted between the locking position and the unlocking position by displacement along the axis of the connecting piece.

5. The quick coupling according to claim 1, wherein the fastening means is detachably connected to the connector.

6. The quick coupling according to claim 1, wherein the fastening means is plugged onto the connector.

7. The quick coupling according to claim 1, wherein the fastening means is connected to the connector in a permanent, captive and/or non-detachable manner.

8. The quick coupling according to claim 1, wherein the fastening means encloses the connecting piece and/or the connecting pipe to its full extent.

9. The quick coupling according to claim 1, wherein the quick coupling comprises:
a locking mechanism for locking the securing means in at least one position with regard to the fastening means.

10. The quick coupling according to claim 1, wherein the securing means and the fastening means comprise: surfaces that are arranged in one position, lying flush against each other.

11. The quick coupling according to claim 1, wherein the connecting pipe comprises:
at least one guide surface for movably guiding the securing means during the conversion between the locking and the unlocking position and/or for positioning fastening means with regard to the connector in a torsion-proof and/or slide-proof manner.

12. The quick coupling according to claim 1, wherein the connecting pipe comprises:
two guide surfaces spaced apart along the axis of the connecting pipe.

13. The quick coupling according claim 1, wherein the latching means comprises:
two resilient latch arms protruding from the connecting piece in circumferential direction of the connecting piece displaced to the connecting pipe.

14. The quick coupling according to claim 1, wherein the connector is substantially designed in an X-, T-, Y- or L-shape, the connector including two connecting pipes, the axes thereof being in one plane, or the axes thereof being in two planes cutting in a region of the axis of the connecting piece.

15. A construction kit for a quick coupling for fluid pipes, comprising:
a connector with a connecting piece and at least one connecting pipe transversely projecting from said connecting piece, the connecting piece being of a type that can be introduced into a receiving opening of a counterpart in a sealing manner and brought into latching engagement with said counterpart by a latching means;
a securing means for securing the latching engagement against unlocking; and
a fastening means for fixing the securing means in at least one position, wherein the connector, the securing means and the fastening means are connectable to each other such that the securing means is convertible between a locking position in which the latching engagement is secured against unlocking and an unlocking position in which the latching engagement can be released, the securing means being fixed to the fastening means in at least one position.
